(19) United States
(12) Patent Application Publication
(10) Pub. No.: US 2019/0342668 A1
(43) Pub. Date: Nov. 7, 2019

(54) Electroacoustic Transducer Device

(71) Applicant: TOKYO ONKYO CO., LTD., Chiyoda-ku, Tokyo (JP)

(72) Inventor: Kenta TANAKA, Fujisawa-Shi, Kanagawa (JP)

(21) Appl. No.: 16/328,962

(22) PCT Filed: Sep. 2, 2016
(86) PCT No.: PCT/JP2016/075781

§ 371 Date: Jul. 23, 2019

(51) Int. Cl. H04R 9/06; H04R 9/02; H04R 7/18; H04R 1/06; H04R 9/04; H04R 7/12

(52) U.S. Cl. CPC H04R 9/06; H04R 9/025; H04R 7/127; H04R 1/06; H04R 9/046; H04R 7/18

(57) ABSTRACT

In an electric sound conversion apparatus, it is possible to reproduce sound of high quality particularly in a low-tone range.

A driving magnet 31 is fixed in a cup-shaped yoke 29, and a vibrating membrane 39 facing a driving magnet at an interval is fixed at a tip portion of the yoke 29 to block it. A voice coil 41 formed by winding an insulated wire is fixed in the vibrating membrane 39 to surround the central region. The voice coil 41 is inserted between an outer periphery of the driving magnet 31 and an inner wall inside the yoke 29. Lead wires at both ends 41a of the voice coil 41 are drawn from diagonal positions. An outer peripheral region 39b faces a sealed space E formed between the outer periphery of the driving magnet 31 and an area inside the yoke 29 from a vicinity of the voice coil 41 in the vibrating membrane 39.

### TECHNICAL FIELD

The present invention relates to an electric sound conversion apparatus, and particularly to improvement of an earphone and a headphone mounted on the ear and head of a user, a speaker device such as a large speaker, and an electric sound conversion apparatus which can be used as a microphone.

### BACKGROUND ART

Conventionally, as a speaker device to be worn on a user's ear, for example, as shown in FIG. 9, a configuration in which one end surface of a cylindrical driving magnet 5 is fixed in a cup-shaped yoke 3 disposed in a case main body 1, a thin diaphragm 7 facing the other end surface of the driving magnet 5 at an interval therebetween is fixed to a tip of the yoke 3 using an adhesive or the like, and a cylindrical voice coil 9 fixed to the diaphragm 7 is inserted into an outer periphery of the driving magnet 5 at a small interval is well known.

The case main body 1 is made from a funnel-shaped base portion 1a and a front cover 1b covering a tip thereof (right side in FIG. 9), and a flexible ear tip (ear pad, earpiece) 13 is fitted to an outer periphery of a sound transmission cylinder 11 protruding from the front cover 1b.

Note that a reference numeral 15 in FIG. 9 is a cable drawn to the outside, and a knot 15a thereof is in the base portion 1a.

In this speaker device, the driving unit 17 for vibrating the diaphragm 7 is formed by the driving magnet 5 and the voice coil 9, the diaphragm 7 is vibrated by applying an audio signal to the voice coil 9 from the outside using the cable 15 to produce sounds, and the produced sounds are propagated to the outside from the sound transmission cylinder 11 on a front of the diaphragm 7.

A speaker device of an actual product is configured as, for example, an earphone device of an external ear canal insertion (canal) type, and is used by inserting the case main body 1 in the cavity of the concha 25 surrounded by a user's tragus 19, antitragus 21, and auricular concha 23 such that the diaphragm 7 is brought near the auricular concha 23, and elastically bringing the ear tip 13 in contact with an inner wall of the external ear canal 27 extending from the cavity of the concha 25 to the eardrum (not shown).

Such actual products include a coaxial type in which a central axis of the sound transmission cylinder 11 is aligned with a central axis of the diaphragm 7 as shown in FIG. 9 described above, and, although not shown, a non-coaxial type in which the central axis of the sound transmission cylinder 11 is set obliquely with respect to the central axis of the diaphragm 7. FIG. 9 shows a state in which the earphone device is wom in a left ear.

Incidentally, Japanese Unexamined Patent Application, First Publication No. 2010-283643 (Patent Document 1) is known as an example of an earphone, and Japanese Unexamined Patent Application, First Publication No. 2008-118331 (Patent Document 2) is known as an example of a speaker device.

### CITATION LIST

### Patent Document

### [Patent Document 1]

Japanese Unexamined Patent Application. First Publication No. 2010-283643

### [Patent Document 2]

Japanese Unexamined Patent Application. First Publication No. 2008-118331

### SUMMARY OF INVENTION

### Technical Problem

However, in the speaker device described above, as shown in FIG. 10A, for example, a configuration in which the lead wires at both ends 9a are drawn from one place of a base of the voice coil 9 to an external space is well known.

In this configuration, when the voice coil 9 is displaced and vibrated by applying an audio signal to the lead wires at both ends 9a, it is known that the following influence on sound reproduction occurs.

That is, in the configuration shown in FIG. 10A, at the drawn position P1 of the lead wires at both ends 9a in the voice coil 9 and a diagonal position P2 diagonal to the position P1, the diaphragm 7 is likely to be displaced more on a diagonal position P2 side than a drawn position P1 side of the lead wires at both ends 9a mainly due to presence or absence of a load of the lead wires at both ends 9a applied to the diaphragm 7.

It is known that this easily influences sound reproduction, and there is room for improvement in reproducing sound of high quality in a wide frequency band.

Furthermore, as shown in FIG. 10B, there is a configuration in which the lead wires at both ends 9a are drawn out from one place of the voice coil 9 to an outer position P3 of the diaphragm 7, and the lead wires at both ends 9a are attached to the outer peripheral region (corrugation edge portion) of the diaphragm 7 up to the outer position P3 using a flexible adhesive (not shown), and, although not shown, there is also a configuration in which the lead wires at both ends are drawn out from two places of the voice coil.

Regardless of whether there is one place or two places at which the lead wires at both ends 9a are drawn out from the voice coil 9, a node of rolling movement of the diaphragm 7 is likely to occur at a corresponding point in the case of one place, and on a line connecting two corresponding places in the case of two places at the time of vibration of the diaphragm 7.

In addition, due to deviation and the like in placement position of the diaphragm 7 on the yoke 3, irregular rocking vibration is likely to occur in the outer peripheral region at the time of vibration of the diaphragm 7.

It is known that this causes abnormal vibration such as an increase of a distortion rate or deterioration of a transient response characteristic, and a chattering sound at the time of a large input of audio signals, and there is room for improvement in reproducing sound of high quality in a wide frequency band.

In light of this, the inventor of the present invention has diligently investigated various configurations to pursue higher quality, and as a result, has found a new configuration to complete the present invention.

The present invention has been made to solve such problems, and an object thereof is to provide an electric sound conversion apparatus which has a wide frequency band and excellent transient response characteristics, and is capable of reproducing sound of high quality particularly in a low-tone range.

### Solution to Problem

In order to solve such a problem, a first configuration related to an electric sound conversion apparatus of the present invention includes a magnetic yoke in a cup-shape which has a through hole in a center of the bottom portion, a cylindrical driving magnet which has one end surface fixed to the yoke bottom portion to align a corresponding hollow portion with the through hole in the yoke, a ring-shaped pole piece which is coaxially overlapped with the other end surface of the driving magnet to align a corresponding hollow portion with the hollow portion of the driving magnet in the yoke, a thin vibrating membrane which is fixed to and closing the tip of the yoke and facing the pole piece with an interval therebetween, and a voice coil which is a voice coil formed in a cylindrical shape by winding a thin insulated wire, and fixed to the vibrating membrane to surround a central region on one side surface of the vibrating membrane on the yoke side, is inserted into an annular gap between an outer periphery of the pole piece and a cylindrical portion of the yoke, and causes the vibrating membrane to vibrate according to an audio signal applied to corresponding lead wires at both ends.

Moreover, the lead wires at both ends are drawn from diagonal positions at a base of the voice coil, an outer peripheral region of the outer periphery faces a sealed space formed in the outer peripheral region and an area inside the yoke from a vicinity of the base of the voice coil in the vibrating membrane, and the sealed space communicates with the hollow portion of the pole piece and the hollow portion of the driving magnet from the annular gap.

In the first configuration related to the electric sound conversion apparatus of the present invention, the pole piece may be formed of a magnetic material in a shape having an outer diameter the same as or larger than the driving magnet, and may form a magnetic circuit between the pole piece and the yoke.

In the first configuration related to the electric sound conversion apparatus of the present invention, the yoke may have an annular flange portion in which the cylindrical portion is bent outward and extends in the vicinity of the pole piece, the vibrating membrane may be fixed to the outer periphery thereof at an interval from the flange portion, and the sealed space may be formed between the outer peripheral region and the flange portion.

In the first configuration related to the electric sound conversion apparatus of the present invention, an adjustment unit for adjusting sound quality characteristics of the electric sound conversion apparatus may be a sound damping air-permeable net that blocks the hollow portion of the driving magnet or the through hole of the yoke.

A second configuration related to the electric sound conversion apparatus of the present invention includes a cylindrical magnetic yoke, a driving magnet which is a ring-shaped driving magnet whose one end surface is coaxially fixed to a fixed portion formed to be bent outward from one end surface side of the yoke, and which circumferentially faces an outer periphery of a cylindrical portion of the yoke at an interval, a ring-shaped support portion which is coaxially fixed to the other end surface of the driving magnet at an outer periphery of the yoke, a thin vibrating membrane fixed to an outer peripheral portion of the support portion to face the yoke and the support portion at an interval, and a voice coil which is a voice coil formed in a cylindrical shape by winding a thin insulated wire and fixed to the vibrating membrane to surround a central region on one side surface of the vibrating membrane on the yoke side, and which is inserted into an annular gap between the outer periphery of the yoke and an inner periphery of the support portion, and cause the vibrating membrane to vibrate according to an audio signal applied to the lead wires at both ends.

Moreover, the lead wires at both ends are drawn from diagonal positions at a base of the voice coil, an outer peripheral region of the outer periphery mainly faces a sealed space formed between the outer peripheral region and the support portion from the vicinity of the base of the voice coil in the vibrating membrane, and the sealed space is connected via a hollow portion of the yoke from the annular gap.

In the second configuration related to the electric sound conversion apparatus of the present invention, the support portion may be formed of a magnetic material in a shape having an inner diameter the same as or smaller than the driving magnet, and may form a magnetic circuit between the support portion and the yoke

In the second configuration related to the electric sound conversion apparatus of the present invention, an adjustment unit for adjusting sound quality characteristics of the electric sound conversion apparatus may be a sound damping air-permeable net that blocks the hollow portion of the yoke directly or indirectly.

### Advantageous Effects of Invention

In the first configuration related to the electric sound conversion apparatus of the present invention, the lead wires at both ends are drawn from diagonal positions of the voice coil, the outer peripheral region mainly faces a sealed space formed between an outer periphery of the driving magnet and an area inside the yoke from a vicinity of the base of the voice coil in the vibrating membrane, and the sealed space communicates with a hollow portion of a pole piece or a driving magnet from the annular gap, and thus a practical sealing degree of the sealed space is secured, a rolling movement of a diaphragm in an inner magnet-type configuration can be prevented, a smooth piston motion movement of a diaphragm can be secured, and, as a result, it is possible to obtain an excellent transient response, a low distortion rate, and a wide frequency band. In particular, it is possible to reproduce sound with high quality in a low-tone range.

In the first configuration related to the electric sound conversion apparatus of the present invention, the pole piece is formed of a magnetic material having an outer diameter the same as or larger than the driving magnet, and forms a magnet circuit between the pole piece and the yoke, and thus an excellent and strong magnetic circuit can be formed between the pole piece and the yoke and it is easy to improve vibration of the vibrating membrane.

In the first configuration related to the electric sound conversion apparatus of the present invention, in the yoke, the cylindrical portion has a flange portion that is bent outward and extends in a vicinity of the other end surface of the driving magnet, the vibrating membrane is fixed to the outer periphery at an interval from the flange portion, and the sealed space is formed between the outer peripheral region and the flange portion, and thus the rolling movement of a diaphragm can be more reliably prevented, and the smooth piston motion movement of a diaphragm described above can be secured.

In the first configuration related to the electric sound conversion apparatus of the present invention, the adjustment unit for adjusting sound quality characteristics of the electric sound conversion apparatus is a sound damping air-permeable net which blocks the hollow portion of the driving magnet or the through hole of the yoke, and thus it is also possible to adjust the sound quality characteristics while maintaining the effect described above.

In the second configuration related to the electric sound conversion apparatus of the present invention, the lead wires at both ends are drawn from diagonal positions of the voice coil, and the outer peripheral region mainly face a sealed space formed between the outer peripheral region and the support portion from the vicinity of the base of the voice coil in the vibrating membrane, and thus the practical sealing degree of the sealed space can be secured, the rolling movement of a diaphragm can be prevented in an external magnet-type configuration, the smooth piston motion movement of a diaphragm can be secured, and as a result, an excellent transient response, a low distortion rate, and a wide frequency band can be obtained. In particular, it is possible to reproduce sound of high quality in a low-tone range.

In the second configuration related to the electric sound conversion apparatus of the present invention, the support portion is formed of a magnetic material in a shape having an inner diameter the same as or smaller than the driving magnet, and thus it can be easy to form an excellent magnetic circuit and to improve the vibration of the vibrating membrane.

In the second configuration related to the electric sound conversion apparatus of the present invention, if the adjustment unit for adjusting the sound quality characteristics of the electric sound conversion apparatus is a sound damping air-permeable net that directly or indirectly blocks the hollow portion of the yoke, it is also possible to adjust the sound quality characteristics while maintaining the effect described above.

### BRIEF DESCRIPTION OF DRAWINGS

FIG. 1 is a main part vertical cross-sectional view which shows one embodiment of a first configuration related to an electric sound conversion apparatus of the present invention.

FIG. 2 is a bottom view and a main part cross-sectional view of a vibrating membrane related to the electric sound conversion apparatus of FIG. 1.

FIG. 3 is a schematic vertical cross-sectional view which shows the electric sound conversion apparatus of the present invention as an earphone device.

FIG. 4 is a frequency characteristic diagram of the electric sound conversion apparatus of FIG. 1 and a conventional electric sound conversion apparatus.

FIG. 5 is a total harmonic distortion characteristic diagram of the electric sound conversion apparatus of FIG. 1 and the conventional electric sound conversion apparatus.

FIG. 6 is a transient response waveform diagram related to the electric sound conversion apparatus of FIG. 1.

FIG. 7 is a transient response waveform diagram related to the conventional electric sound conversion apparatus.

FIG. 8 is a main part vertical cross-sectional view which shows one embodiment of a second configuration related to the electric sound conversion apparatus of the present invention.

FIG. 9 is a cross-sectional view which shows the conventional electric sound conversion apparatus with examples of use.

FIG. 10 is a schematic diagram which describes operations of the conventional electric sound conversion apparatus and the electric sound conversion apparatus of the present invention.

### DESCRIPTION OF EMBODIMENTS

Hereinafter, embodiments of an electric sound conversion apparatus according to the present invention will be described with reference to the drawings using a speaker device (for example, an earphone device) as an example.

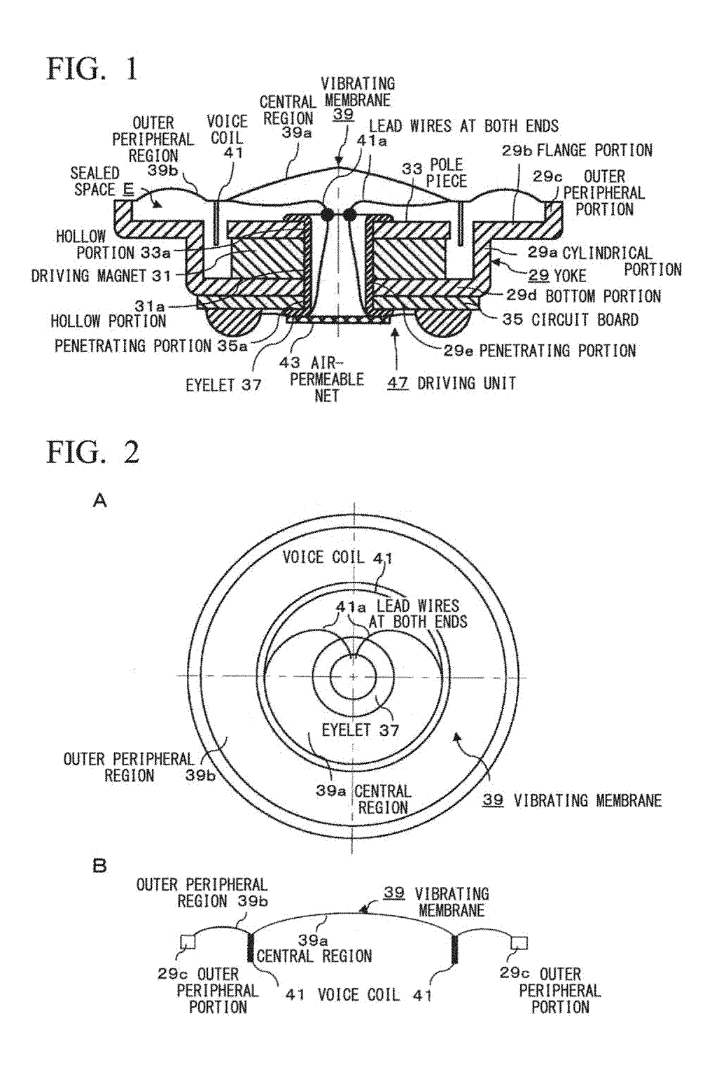

FIG. 1 is a main part vertical cross-sectional view which shows one embodiment of a first configuration related to an electric sound conversion apparatus of the present invention.

In FIG. 1, a yoke 29 is molded and processed in a cup shape from a magnetic material plate material, integrally has a flat flange portion 29b of a ring plate shape formed by bending an open end side (a upper side in FIG. 1) of this cylindrical portion 29a to the outside, and bends the flat flange portion 29b to slightly raise an outer peripheral portion 29c of this flange portion 29b upward in FIG. 1.

A through hole 29e is formed in the center of a bottom portion 29d of the yoke 29, and a ring-shaped driving magnet 31 is accommodated in the yoke 29 such that a hollow portion 31a is aligned with the through hole 29e. In other words, the driving magnet 31 is accommodated in the yoke 29 by overlapping one end surface (a lower side in FIG. 1) on the bottom portion 29d to surround the through hole 29a.

A ring-shaped pole piece 33 formed from a magnetic material having an outer diameter equal to or slightly larger than the outer diameter of the driving magnet 31 is overlapped with the other end surface (the upper side in FIG. 1) of the driving magnet 31. A reference numeral 33a in FIG. 1 denotes a hollow portion 33a formed to be aligned with the hollow portion 31a of the driving magnet 31.

On the outside of the bottom portion 29d of the yoke 29, a circuit board 35 having a through hole 35a is overlapped such that the through hole 35a and the through hole 29e are aligned.

The yoke 29, the driving magnet 31, the pole piece 33, and the circuit board 35 are coaxially integrated and are fixed to the bottom portion 29d of yoke 29 by caulking, for example, both ends of a tubular eyelet 37 penetrating through the hollow portions 31a and 33a and the through holes 29e and 35a from sides of the pole piece 33 or the circuit board 35.

The yoke 29, the driving magnet 31, the pole piece 33, and the circuit board 35 may be coaxially integrated using an adhesive or the like (not shown), and fixed to the yoke 29.

The pole piece 33 has the outer periphery circumferentially facing a tip portion of the cylindrical portion 29a of the yoke 29, that is, a level position substantially the same as a bent portion from the cylindrical portion 29a to the flange portion 29b, and is formed from a magnetic flux concentration member for obtaining high sound quality (the same applies hereinafter), but it can be regarded as the same thing as the driving magnet 31.

A magnetic circuit is formed due to a magnetic flux from the yoke 29 between the outer periphery of the pole piece 33 and the tip portion of the cylindrical portion 29a of the yoke 29 facing the outer periphery of the pole piece 33 at a small interval.

As shown in FIG. 2, a vibrating membrane 39 is formed from a conventionally known thin insulating film material in a disk shape, and has a central region 39a formed by inflating a relatively large central part slightly in a dome shape, and an outer peripheral region 39b which concentrically and annularly surrounds this central region 39a. FIG. 2A shows the vibrating membrane 39 from the pole piece 33 side.

The central region 39a of the vibrating membrane 39 is formed in a dome shape in which split vibration and the like do not easily occur at the time of vibration and deformation is not easily performed.

Radial fine concavo-convex lines known as corrugation edges, although not shown, are formed in the outer peripheral region 39b, and the outer peripheral region 39b easily bends and has high flexibility with respect to vibration as compared with the central region 39a.

That is, the central region 39a does not bend as easily and has stronger rigidity than the outer peripheral region 39b. It is preferable for the central region 39a to have stronger rigidity than the outer peripheral region 39b, for example, about 1.5 times, preferably 2 to 5 times. However, it is important to keep it within a rigidity range in which good vibration of the vibrating membrane 39 including the central region 39a is secured.

As shown in FIG. 1, the vibrating membrane 39 covers the flange portion 29b of the yoke 29 and the pole piece 33 with a space with respect thereto, and fixes an entire circumference of an outer edge of the outer peripheral region 39b to the outer peripheral portion 29c of the flange portion 29a using an adhesive to be supported by this fixation.

On one surface side of the vibrating membrane 39 (a lower surface side in FIG. 1), one end surface side of the cylindrical voice coil 41 is fixed to an annular boundary between the central region 39a and the outer peripheral region 39b to surround the central region 39a.

The voice coil 41 is formed integrally by winding a thin insulated wire coated with insulation in a cylindrical shape. In an annular gap between an inner wall of the cylindrical portion 29a of the yoke 29 and an outer periphery of the driving magnet 31 or the pole piece 33, the yoke 29 and the driving magnet 31 or the pole piece 33 are inserted at a small interval, and they annularly face the inner periphery of yoke 29 and the outer periphery of the driving magnet 31, respectively.

The lead wires at both ends 41a from the voice coil 41 are drawn from diagonal positions, and are drawn to the outside via a hollow portion of the tubular eyelet 37, that is, the hollow portions 31a of the pole piece 33 and the driving magnet 31, and the bottom portion 29d of the yoke 29 and through holes 29e and 35a of the circuit board 35, and are connected to the circuit board 37.

Note that the lead wires at both ends 41a are wired in the air with a margin so as not to be stressed even by vibration of the vibrating membrane 39 to be described below, but the lead wire is not necessarily drawn via the hollow portion 31a and the like of the pole piece 33 and the driving magnet 31.

Moreover, the outer peripheral region 39b faces a sealed space E formed between the outer peripheral region 39b and the yoke 29 in the flange portion 29b from a vicinity of a base of the voice coil 41.

The sealed space E is indirectly sealed in communication with the outside via a narrow gap between the voice coil 41 and the driving magnet 31 or the pole piece 33 from a narrow gap between the cylindrical portion 29a of the yoke 29 and the voice coil 41, that is, via the hollow portion of the eyelet 37 from a narrow annular gap between the outer periphery of the driving magnet 31 or the pole piece 33 and the cylindrical portion 29a of the yoke 29.

For this reason, the sealed space E has a function of supporting an entire outer peripheral region 39b of the voice coil 41 using a uniform load.

A reference numeral 43 in FIG. 1 denotes an air-permeable net for sound damping which blocks a hollow portion of the eyelet 39 from a side of the circuit board 37, is formed of, for example, a nonwoven fabric or the like, and is capable of adjusting sound quality by varying an amount of ventilation between the vibrating membrane 39 side and the outer side of the yoke 29 according to a roughness thereof. The air-permeable net 43 may be anything as long as it blocks the through hole 29e of the yoke 29 or the follow portion 31a of the driving magnet 31.

An audio signal is supplied from an electronic device (not shown) to the circuit board 37 overlapping the bottom portion 29d of the yoke 29 by a cable 45 to be described below.

The voice coil 41 is displaced, and the vibrating membrane 39 is driven to vibrate by applying the audio signal to the voice coil 41 via the lead wires at both ends 41a.

That is, a driving unit 47 for driving the vibrating membrane 39 to vibrate is formed by the yoke 29, the driving magnet 31, and the voice coil 41, and is a main part of a so-called inner magnet-type speaker device.

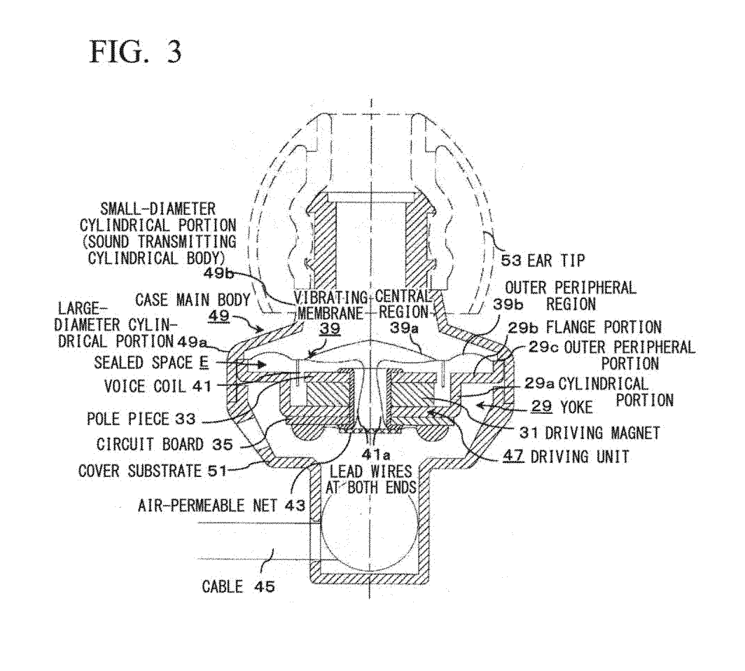

The yoke 29, as shown in FIG. 3, has the outer peripheral portion 29c of the flange portion 29b fitted in a cap-shaped case main body 49 and is supported in the case main body 49.

The case main body 49 described above has a large-diameter cylindrical portion 49a fitted with the outer periphery of the yoke 29 and a small-diameter cylindrical portion 49b which has substantially the same size as the yoke 29 continuously from this large-diameter cylindrical portion 49a, and is molded integrally from an insulating synthetic resin or the like.

The yoke 29, the driving magnet 31, and the pole piece 33 are integrated and fitted in the large-diameter cylindrical portion 49a, and are fixedly supported inside the large-diameter cylindrical portion 49a.

The small-diameter cylindrical portion 49b of the case main body 49 is a sound transmission cylinder which covers the vibrating membrane 39 at an interval and extends to protrude upward in FIG. 1.

In the speaker device having the configuration described above, a cover 51 and the like are placed on the outside of the large-diameter cylindrical portion 49a in the case main body 49 to cover the yoke 29 and the circuit board 35, and the flexible ear tip 53 is fitted to the outer periphery of the small-diameter cylindrical portion 49b to be commercialized as an earphone device.

In such a speaker device, the driving unit 47 cause the vibrating membrane 39 to vibrate and produce sounds, and the vibration sounds are propagated to the outside via the small-diameter cylindrical portion 49b which is a sound transmission cylinder by supplying an audio signal from the cable 45 via the circuit board 35 and applying an audio signal to the voice coil 41.

Then, as shown in FIG. 9 described above, the speaker device according to the present invention accommodates the case main body 49 in the cavity of concha 25 surrounded by the tragus 19, the antitragus 21, and the auricular concha 23, and the ear tip 53 at a tip thereof is inserted into the external ear canal 27, and is worn to be used.

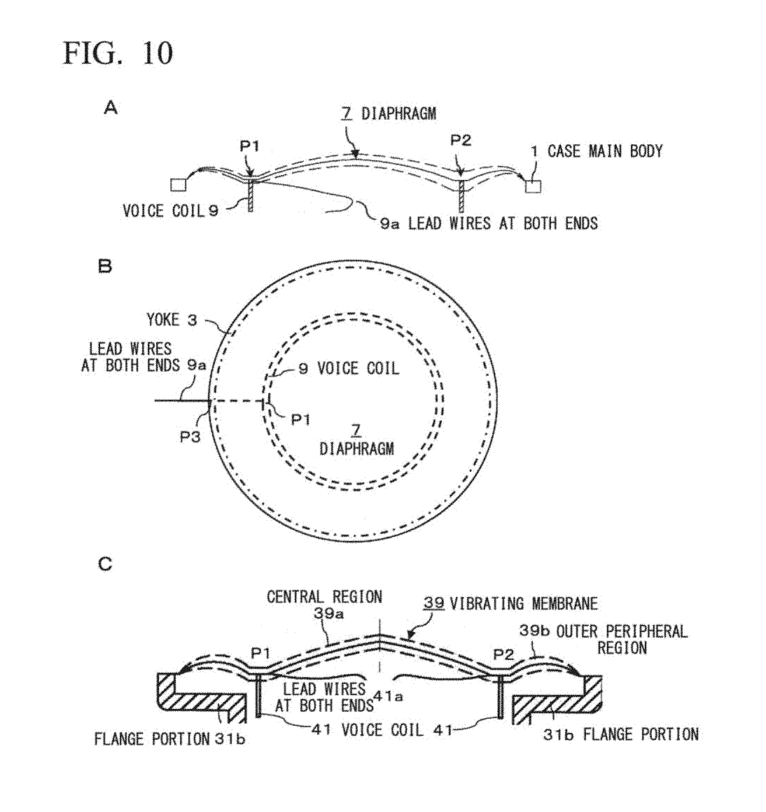

In such a configuration related to the speaker device of the present invention, as shown in FIG. 10C, since a load position caused by the drawn positions P1 and P2 of the lead wires at both ends 41a from the voice coil 41 is a diagonal position of the voice coil 41, displacement of both of the drawn positions P1 and P2 is easy to be aligned, and it is easy to reproduce sound of high quality in a wide frequency band.

However, also in the configuration related to the speaker device of the present invention, at the time of vibrating the vibrating membrane 39, an imaginary line (not shown) connecting the drawn positions P1 and P2 becomes a node and there is a concern that a rolling movement around this node may occur.

In this respect, in the speaker of the present invention, the sealed space E facing the outer peripheral region 39b of the vibrating membrane 39 is a narrow and flat space formed between the flange portion 29b of the yoke 29 and the outer peripheral region 39b of the vibrating membrane 39, and it faces the entire circumference of the outer peripheral region 39b of the vibrating membrane 39 and functions as an air damper. Even if the vibrating membrane 39 vibrates, the vibrating membrane 39 is held with a uniform mechanical load applied to the entire circumference of the outer peripheral region 39b, and rolling vibration hardly occurs at the time of vibration and ruffling of the outer peripheral region 39b of the vibrating membrane 39 is unlikely to occur.

With such operations, it is possible to uniformly displace the entire vibrating membrane 39 in a piston mode, and to reproduce sound of high quality with a wide frequency band and excellent transient response waveform, particularly, in a low-tone range. Specifically, a sense of localization of musical instruments and the like improves and it is easy to discriminate the reproduced sound.

On the other hand, in a conventional speaker device, since a vibration amplitude of the vibrating membrane 39 becomes large to improve a low frequency, the rolling movement becomes larger, and abnormal vibration such as an increase in distortion and occurrence of chattering sound is likely to occur.

In the conventional speaker device, as shown in FIG. 10A, the diaphragm 7 is likely to generate an operation called unbalanced rolling due to a load of the lead wires at both ends 9a, and the diaphragm 7 is designed on the premise of this, and thus it is common that a portion corresponding to the central region 7a is set to be in a spherical shape to vibrate in a form of being bent to some extent to absorb distortion at the time of vibration of the diaphragm 7 to some extent.

Then, in the conventional structure, if the rigidity of the vibrating membrane 41 increases as in the present invention, further distortion occurs in the outer peripheral region 39b which vibrates while being bent, and abnormal vibration sound and the like easily occur.

In the configuration of the present invention, since the rolling movement hardly occurs, distortion such as twisting is less likely to occur also in the outer peripheral region 39b, and a degree of freedom in designing a corrugation edge portion can be improved far more than in the conventional configuration. Moreover, since there is little occurrence of distortion, chattering sound, and the like, a low frequency response can be controlled relatively freely.

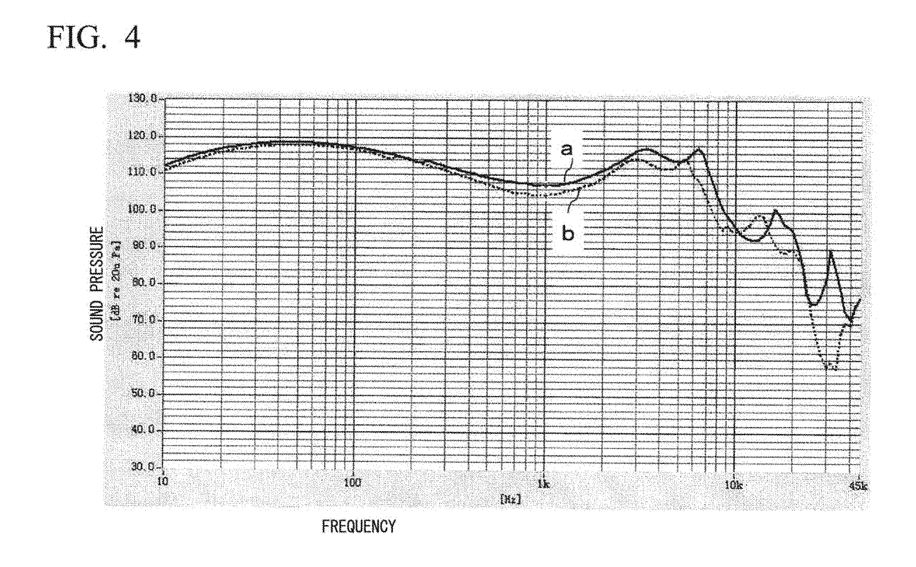

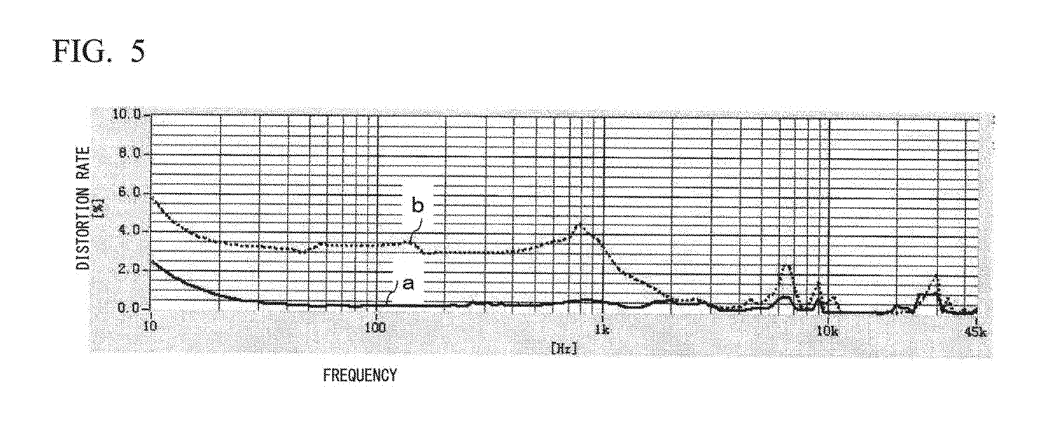

In the configuration related to the speaker device of the present invention, like a total harmonic distortion characteristic indicated by a solid line a in FIG. 4, a characteristic that distortion is low particularly up to a low-tone range is shown, it is known that high quality sound reproduction is possible in a wide frequency band, and a harmonic distortion rate characteristic is low and flat like the total harmonic distortion characteristic indicated by a solid line a in FIG. 5.

On the other hand, as shown in FIG. 10A, in the conventional configuration in which the lead wires at both ends 9a are drawn out from the base of the voice coil 9, the total harmonic distortion characteristic in the low-tone range is easily deteriorated like a frequency characteristic indicated by a broken line b in FIG. 4, and the harmonic distortion rate characteristic is bad, and deterioration of the middle to low-tone range, particularly before and after 1 KHz or less, is outstanding like the total harmonic distortion characteristic indicated by a broken line b in FIG. 5.

In the present invention, the lead wires at both ends 41a of the voice coil 9 are drawn from two places at the diagonal position as shown in FIGS. 1 and 2A, and in conjunction with a braking effect of applying an air pressure to the entire outer peripheral region 39b using the sealed space E, a load on the drawn portion of the lead wires at both ends 41a is reduced.

In addition, even in deriving of the lead wires at both ends 9a from one place shown in FIG. 10A, the braking effect of applying an air pressure to the entire outer peripheral region 39b using the sealed space may be obtained, but deriving from two places naturally has a small load to the outer peripheral region 39b, and obtains good results in term of performance.

The sealed space E in the first configuration of the present invention is formed in the outer periphery of the driving magnet 31 and an area inside the yoke 29 and faces the outer peripheral region 39b of the outer periphery from a vicinity of the base of the voice coil 41 in the vibrating membrane 39. The sealed space E may not necessarily completely sealed, and may have an air chamber function of supporting a load of the outer peripheral region 39b of the vibrating membrane 39.

For example, the sealed space E may also indirectly communicate with the outside from an annular gap (for example, about 0.3 mm) between the driving magnet 31 or the pole piece 33 and the yoke 29 via a hollow portion 31a of the driving magnet 31 and a through hole 29e of the yoke 29, and, if fine holes are provided in the vibrating membrane 39 to adjust deviation of a resonant frequency of the vibrating membrane 39 from a desired value, the operation and effect of the present invention are not hindered.

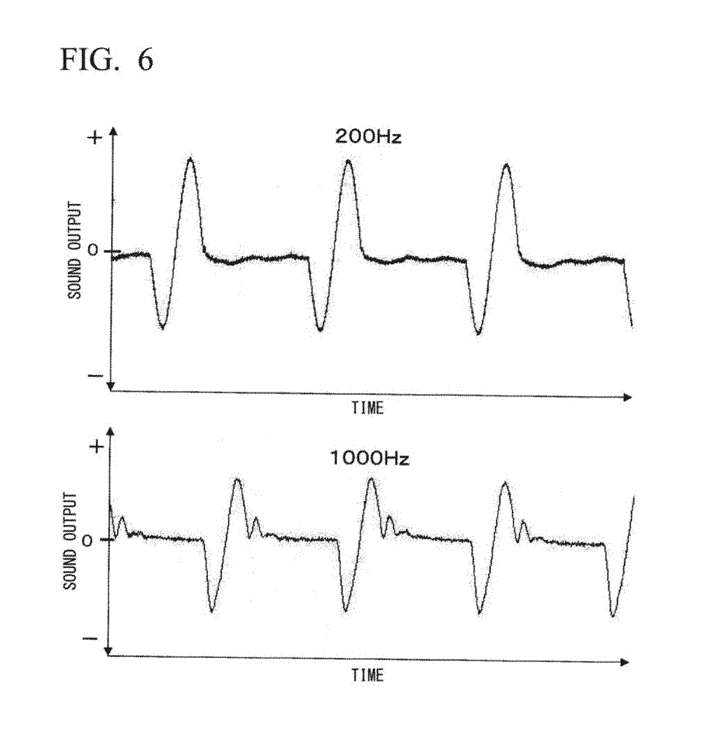

Furthermore, the transient response waveform shown in the configuration of the speaker device according to the present invention is as shown in FIG. 6, and it is known that a disturbance of an output signal waveform when tone burst signals with 200 Hz and 1000 Hz are applied is small and the transient response waveform is good.

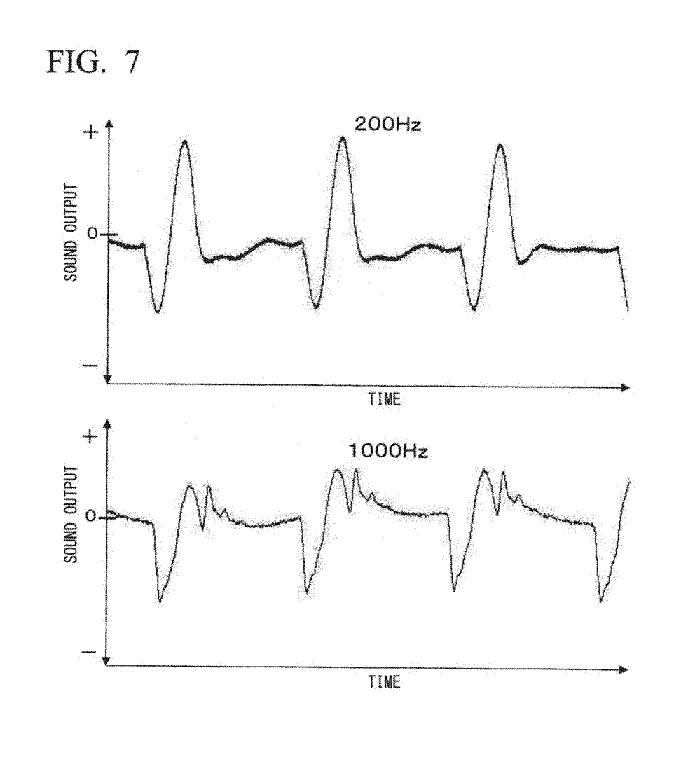

On the other hand, in the conventional configuration of FIG. 10A, as shown in FIG. 7, it is ascertained that a relatively large disturbance occurs in the output signal waveform when tone burst signals with 200 Hz and 1000 Hz are applied, and the transient response waveform of the speaker device according to the present invention is improving.

In this manner, in the first configuration related to the speaker device of the present invention, the speaker device has a wide frequency band and an excellent transient response characteristic, and is capable of reproducing sound of high quality, particularly, in a low-tone range.

The speaker device of the present invention is not limited to the inner magnet-type configuration described above, and can also be a so-called external magnet-type speaker device.

Next, a second configuration related to the speaker device of the present invention, that is, an external magnet-type speaker device, will be described.

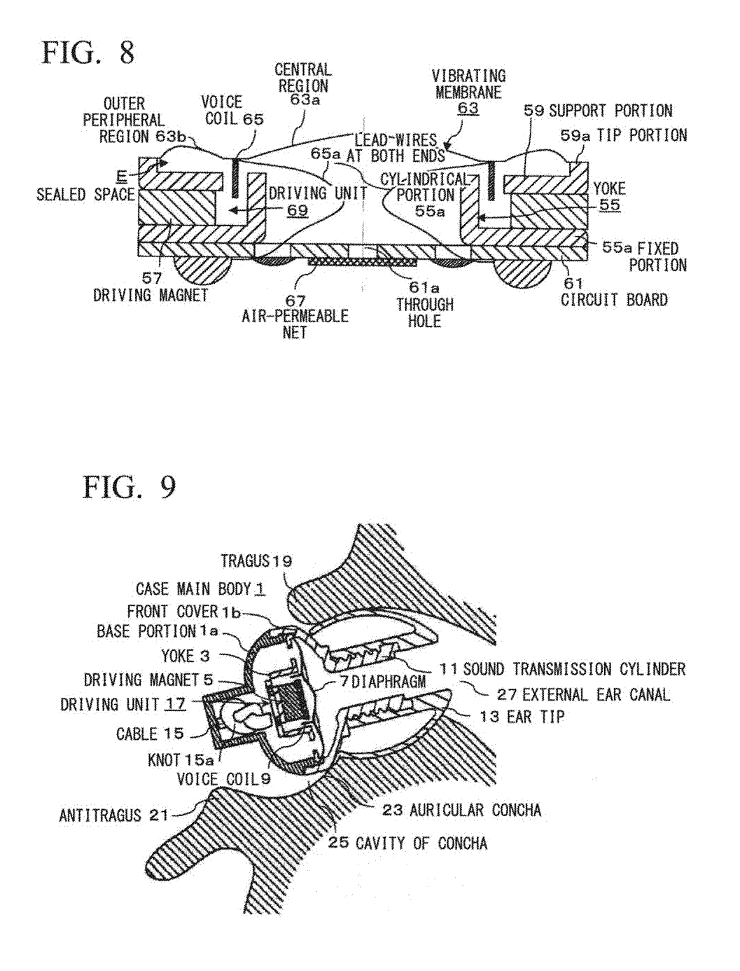

FIG. 8 is a main part vertical cross-sectional view which shows one embodiment of a second configuration related to the speaker device of the present invention.

In FIG. 8, the yoke 55 is molded and processed in a cylindrical shape from a magnetic material plate material, and integrally has a flat fixed portion 55a of a ring plate shape formed by bending the open end on a lower side in FIG. 8 outward.

On the outer periphery of the yoke 55, a ring-shaped driving magnet 57 is fitted coaxially with an outer periphery of this cylindrical portion 55b at an interval, and one end surface thereof (a lower side in FIG. 8) is fixed to the fixed portion 55a.

On the other end surface of the driving magnet 57 (on an upper side in FIG. 8), a support portion 59 having an inner diameter substantially the same size as or slightly smaller than the inner diameter of the driving magnet 57, and formed in a ring plate shape from a magnetic material is overlapped, and an outer peripheral tip portion 59a of the support portion 59 is bent slightly upward (the upper side in FIG. 8). This support portion 59 forms a magnetic circuit between the support portion 59 and the yoke 55.

The driving magnet 57 and the support portion 59 have the outer peripheries aligned, and an inner periphery of the support portion 59 protrudes further inwardly than that of the driving magnet 57, but both inner peripheries are substantially aligned, and the support portion 59 is circumferentially facing at substantially the same level position as the other tip portion of the yoke 55. The support portion 59 corresponds to the pole piece 33 in the first configuration.

A circuit board 61 having a through hole 61a is overlapped outside the fixed portion 55a of the yoke 55.

The fixed portion 55a of the yoke 55, the driving magnet 57, the support portion 59, and the circuit board 61 are coaxially integrated using, for example, adhesive, and fixed to the fixed portion 55a of yoke 55.

A magnetic circuit is formed by a magnetic flux from the yoke 55 between the inner periphery of the support portion 59 and the tip portion of the yoke 55 facing the inner periphery of the support portion 59 at a small interval therebetween.

Similarly to FIG. 2, the vibrating membrane 63 is formed in a disk shape from a conventionally known thin insulating film material, and has a central region 63a formed by inflating the relatively large central portion in a slightly dome shape and an outer peripheral region 63b concentrically and annularly surrounding this central region 63a. Other configurations of the vibrating membrane 63 are similar to those of the vibrating membrane 39 in FIG. 2.

The vibrating membrane 63 covers the yoke 55 and the support portion 59 with space against them, and fixes an entire outer edge of the outer peripheral region 63b to the tip portion 59a of the support portion 59 using an adhesive or the like to be supported thereby.

On one surface side of the vibrating membrane 63 (on a lower surface side in FIG. 8), one end surface side of a cylindrical voice coil 65 is fixed to an annular boundary between the central region 63a and the outer peripheral region 63b to surround the central region 63a.

Like the voice coil 41 described above, the voice coil 65 is formed by integrally winding a thin insulated wire coated with insulation in a cylindrical shape, is inserted into an annular gap between the outer wall of the yoke 55 and the inner periphery of the driving magnet 57 or the support portion 59 at a small interval between the yoke 55 and the driving magnet 57 or the support portion 59, and annularly faces the outer periphery of yoke 55 and the inner periphery of the driving magnet 57 and the support portion 59.

The lead wires at both ends 65a from the voice coil 65 are drawn from the diagonal position, and are connected to the circuit board 61 through the circuit board 61 via a hollow portion of the yoke 55.

From the vicinity of the base of the voice coil 65, the outer peripheral region 63b faces the sealed space E formed between the outer peripheral region 63b and the support portion 59.

This sealed space E communicates with the outside via the hollow portion of the yoke 55 and the penetrating portion 61a of the circuit board 61 from a narrow gap between the yoke 55 and the voice coil 65 after passing through a gap between the support portion 59 or the driving magnet 57 and the voice coil 65 to be indirectly sealed, and has a function of supporting the entire outer peripheral region 63b of the voice coil 65 using a uniform load.

In FIG. 1, a reference numeral 67 denotes a sound damping air-permeable net which blocks the through hole 61a of the circuit board 61, is formed of, for example, a nonwoven fabric and the like, and, similarly to the air-permeable net 43 described above, can adjust a sound quality by varying an amount of ventilation between the vibrating membrane 63 side and the outer side of the yoke 55 according to a roughness thereof.

An audio signal is supplied from an electronic device (not shown) to the circuit board 61 overlapped with the fixed portion 55a of the yoke 55 through a cable (not shown).

The voice coil 65 is displaced and the vibrating membrane 63 vibrates and is driven by applying an audio signal to the voice coil 65 via the lead wires at both ends 65a.

That is, the driving unit 69 for driving the vibrating membrane 63 to vibrate is formed by the yoke 55, the driving magnet 57, and the voice coil 65, and is a main part of a so-called external magnet-type speaker device.

As shown in FIG. 3, the yoke 55 is fitted into the case main body 49 of a cap shape and supported in the case main body 49 in the same manner, but illustration and description thereof will be omitted. The same applies to a product development example and an example of use as earphone device.

In such a speaker device of the second configuration, by supplying an audio signal via the circuit board 61 and applying the audio signal to the voice coil 65, the driving unit 69 vibrates the vibrating membrane 63 to produce sound and a vibration sound is propagated to the outside.

The sealed space E in the second configuration of the present invention is formed and faces between the support portion 59 (the driving magnet 57) and the outer peripheral region 63b of the vibrating membrane 63 in the outside portion of the yoke 55, is not necessarily completely sealed, and is the same as that in the first configuration as long as it has a function of supporting a load of the outer peripheral region 63b of the vibrating membrane 63.

In addition, in the second configuration of the present invention, the operation and effect are also the same as those in the first configuration, the frequency characteristic and the total harmonic distortion characteristic are as shown in FIGS. 4 and 5, and the configuration has a wide frequency band and an excellent transient response characteristic, and it is possible to reproduce sound of high quality especially in a low-tone range.

In the speaker device of the present invention, in addition to a configuration in which a sound transmission cylinder formed at the small-diameter cylindrical portion 49b of the case main body 49 protrudes along a central axis of the case main body (small-diameter cylindrical portion) 49, it is also possible to have a configuration in which the sound transmission cylinder protrudes in an oblique direction with respect to the central axis.

Note that the electric sound conversion apparatus of the present invention can be widely used as a speaker device such as a headphone or a large speaker, and furthermore as a microphone.

### REFERENCE SIGNS LIST

1, 49 Case main body
1a Base portion
1b Front cover
29, 55 Yoke
5, 31, 57 Driving magnet
7 Diaphragm
9, 41, 63 Voice coil
9a, 41a, 65a Lead wires at both ends
11 Sound transmission cylinder
13, 53 Ear tip (ear pad, earpiece)
15, 45 Cable
15a Knot
17, 47, 69 Driving unit
19 Tragus
21 Antitragus
23 Auricular concha
25 Cavity of concha
27 External ear canal
29a. 55b Cylindrical portion
29b Flange portion
29c Outer peripheral portion
29d Bottom portion
29e, 35a Penetrating portion
31a. 33a Hollow portion
33 Pole piece
35, 61 Circuit board
37 Eyelet
39, 63 Vibrating membrane
39a, 63a Central region
39b, 63b Outer peripheral region
43, 67 Air-permeable net
49a Large-diameter cylindrical portion
49b Small-diameter cylindrical portion
51 Cover substrate
59 Support portion
59a Tip portion
E Sealed space
P1, P2, P3 Drawn position

1. An electric sound conversion apparatus comprising:
a magnetic yoke in a cup-shape which has a through hole in a center of the bottom portion;
a cylindrical driving magnet which has one end surface fixed to the yoke bottom portion to align a corresponding hollow portion with the through hole in the yoke;
a ring-shaped pole piece which is coaxially overlapped with the other end surface of the driving magnet to align a corresponding hollow portion with the hollow portion of the driving magnet in the yoke;
a thin vibrating membrane fixed to and closing the tip of the yoke and facing the pole piece with an interval therebetween; and
a voice coil which is a voice coil formed in a cylindrical shape by winding a thin insulated wire, and fixed to the vibrating membrane to surround a central region on one side surface of the vibrating membrane on the yoke side, is inserted into an annular gap between an outer periphery of the pole piece and a cylindrical portion of the yoke, and causes the vibrating membrane to vibrate according to an audio signal applied to corresponding lead wires at both ends,
wherein the lead wires at both ends are drawn from diagonal positions at a base of the voice coil, an outer peripheral region of the outer periphery faces a sealed space formed in the outer peripheral region and an area inside the yoke from a vicinity of the base of the voice coil in the vibrating membrane, and the sealed space communicates with the hollow portion of the pole piece and the hollow portion of the driving magnet from the annular gap.

2. The electric sound conversion apparatus according to claim 1,
wherein the pole piece is formed of a magnetic material in a shape having an outer diameter the same as or larger than the driving magnet, and forms a magnetic circuit between the pole piece and the yoke.

3. The electric sound conversion apparatus according to claim 1, wherein the yoke has an annular flange portion in which the cylindrical portion is bent outward and extends in the vicinity of the pole piece, the vibrating membrane is fixed to the outer periphery thereof at an interval from the flange portion, and the sealed space is formed between the outer peripheral region and the flange portion.

4. The electric sound conversion apparatus according to claim 1, wherein an adjustment unit for adjusting sound quality characteristics of the electric sound conversion apparatus is a sound damping air-permeable net that blocks the hollow portion of the driving magnet or the through hole of the yoke.

5. An electric sound conversion apparatus comprising:
a cylindrical magnetic yoke;
a driving magnet which is a ring-shaped driving magnet whose one end surface is coaxially fixed to a fixed portion formed to be bent outward from one end surface side of the yoke, and which circumferentially faces an outer periphery of a cylindrical portion of the yoke at an interval;
a ring-shaped support portion which is coaxially fixed to the other end surface of the driving magnet at an outer periphery of the yoke;
a thin vibrating membrane fixed to an outer peripheral portion of the support portion to face the yoke and the support portion at an interval; and
a voice coil which is a voice coil formed in a cylindrical shape by winding a thin insulated wire and fixed to the vibrating membrane to surround a central region on one side surface of the vibrating membrane on the yoke side, and which is inserted into an annular gap between the outer periphery of the yoke and an inner periphery of the support portion, and causes the vibrating membrane to vibrate according to an audio signal applied to the lead wires at both ends,
wherein the lead wires at both ends are drawn from diagonal positions at a base of the voice coil, an outer peripheral region of the outer periphery mainly faces a sealed space formed between the outer peripheral region and the support portion from the vicinity of the base of the voice coil in the vibrating membrane, and the sealed space is connected via a hollow portion of the yoke from the annular gap.

6. The electric sound conversion apparatus according to claim 5, wherein the support portion is formed of a magnetic material in a shape having an inner diameter the same as or smaller than the driving magnet, and forms a magnetic circuit between the support portion and the yoke.

7. The electric sound conversion apparatus according to claim 5, wherein an adjustment unit for adjusting sound quality characteristics of the electric sound conversion apparatus is a sound damping air-permeable net that blocks the hollow portion of the yoke directly or indirectly.
